(19) United States
(12) Patent Application Publication
(10) Pub. No.: US 2009/0111439 A1
(43) Pub. Date: Apr. 30, 2009

(54) SYSTEM AND METHOD FOR MONITORING A MONITORED MOBILE PHONE

(75) Inventor: HSIEN-CHUNG LIN, Tucheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/168,870

(22) Filed: Jul. 7, 2008

(30) Foreign Application Priority Data
Oct. 25, 2007 (CN) 200710202261.1

(51) Int. Cl. H04M 3/42

(52) U.S. Cl. 455/414.2

(57) ABSTRACT

A method for monitoring a monitored mobile phone is provided. The method includes setting a time for sending unauthorized call information to the monitoring mobile phone. The method further includes saving call information of a phone connection between the monitored mobile phone and a first phone in the monitored mobile phone if the phone connection is an unauthorized call, and sending the call information to the monitoring mobile phone according to the set time.

### BACKGROUND

1. Field of the Invention

Embodiments of the present disclosure relate to a system and method for monitoring a monitored mobile phone.

2. Description of Related Art

Nowadays, mobile phones are being widely used by more and more people. Many parents provide mobile phones for their children as a means to remotely communicate with their children. To protect their children from strangers or welcomed phone calls, parents may set one or more authorized phone numbers in their children's phone to be in an authorized call mode. In the authorized call mode, the children's mobile phones can only communicate with other phones corresponding to the one or more authorized phone numbers set by their parents. However, with personal growth and development, their children would like to keep contact with more friends through their mobile phones freely.

Accordingly, what is needed is a system and method for monitoring a monitored mobile phone, which can monitor unauthorized call in a monitored mobile phone.

### SUMMARY OF THE INVENTION

A system for monitoring a monitored mobile phone is provided. The communicates with a monitoring mobile phone via a communication network. The system includes a determining module, a setting module, a storing module and a call information sending module. The determining module is configured for detecting if the monitored mobile phone is establishing a phone connection to a first phone via the communication network, and for determining if the phone connection is an unauthorized call. The setting module is configured for setting a time for sending an unauthorized call information to the monitoring mobile phone, wherein the unauthorized call information comprises information about the first phone. The storing module is configured for saving the unauthorized call information of the phone connection in the monitored mobile phone upon the condition that the phone connection is an unauthorized call. The call information sending module is configured for sending the unauthorized call information to the monitoring mobile phone according to the set time.

Other systems, methods, features, and advantages will be or become apparent to one of ordinary skill in the art upon examination of the following drawings and detailed description.

### BRIEF DESCRIPTION OF THE DRAWINGS

FIG. 1 is a block diagram of one embodiment of a system for monitoring a monitored mobile phone;

FIG. 2 is a block diagram of one embodiment of function modules of the monitored mobile phone 1 and the monitoring mobile phone 2 in FIG. 1;

FIG. 3 is a flowchart illustrating one embodiment of a method for monitoring a monitored mobile phone.

### DETAILED DESCRIPTION OF CERTAIN INVENTIVE EMBODIMENTS

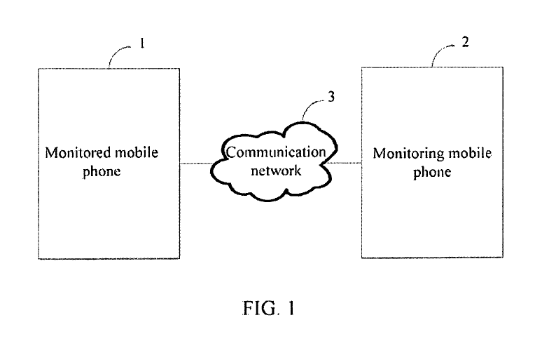

FIG. 1 is a block diagram of one embodiment a system for monitoring a monitored mobile phone. The unauthorized call monitoring system is implemented in a monitored mobile phone 1 and a monitoring mobile phone 2. The monitored mobile phone 1 and the monitoring mobile phone 2 can communicate with each other via a communication network 3.

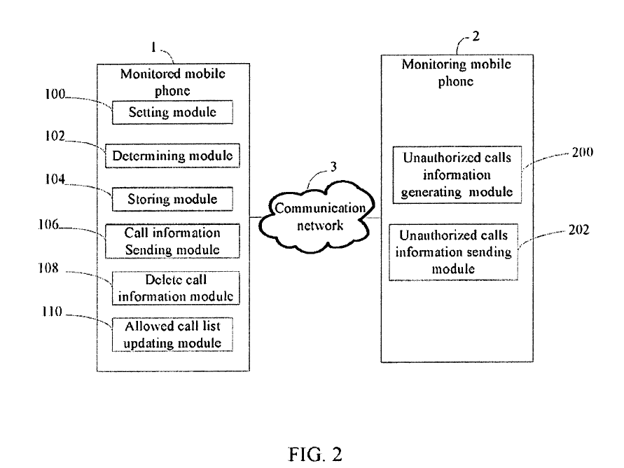

FIG. 2 is a block diagram of one embodiment of the monitored mobile phone 1 and the monitoring mobile phone 2 comprising function modules. The software function modules may be used to implement certain functions and will be described in greater detail below. In one embodiment, the monitored mobile phone 1 includes a setting module 100, a determining module 102, a storing module 104, a call information sending module 106, a delete call information module 108, and an allowed call list updating module 110. In one embodiment, the monitoring mobile phone 2 includes an unauthorized call information setting module 200, and an unauthorized call information sending module 202.

The setting module 100 is configured for setting a time for sending unauthorized call information to the monitoring mobile phone 2. For example, if the time set at 8:00 am every day, then the unauthorized call information would be sent to the monitoring mobile phone 2 at 8:00 am every day.

The determining module 102 may determine whether the monitored mobile phone 1 is establishing a phone connection. The determining module 102 is also configured for determining whether the phone connection is an unauthorized call. In one embodiment, the determining if the phone connection is an authorized call includes at least verifying if a number of an authorized call matches a list of authorized numbers stored in the monitoring mobile phone 2. It may be understood that the determining may include other security measures such as the ones discussed below.

The storing module 104 is configured for saving an unauthorized call information of the phone connection if the phone connection is an unauthorized call. In one embodiment, the unauthorized call information may include a phone number of the unauthorized call, a date of the authorized call, and a time of the unauthorized call.

The call information sending module 106 is configured for sending the unauthorized call information, saved by the storing module 104, to the monitoring mobile phone 2 according to the time.

The delete call information module 108 is configured for deleting the unauthorized call information from the monitored mobile phone 1.

The unauthorized call information generating module 200 of the monitoring mobile phone 2 is configured for generating the unauthorized call information of the unauthorized call. The unauthorized call information generating module 20 may include adding a phone number of the unauthorized call to an allowed call list of the monitored mobile phone 1 and setting a personal identification number 2 (PIN2) for the monitored mobile phone 1. In one embodiment, the PIN2 may be a cipher for entering a specific function of the monitored mobile phone 1.

The unauthorized call information sending module 202 is configured for sending the unauthorized call information to the monitored mobile phone 1.

The determining module 102 is further configured for determining if the PIN2 of the unauthorized call information is valid for the monitored mobile phone 2. In one embodiment, if the PIN2 of the unauthorized call information is the same as a PIN2 in the monitored mobile phone 1, then the determining module 102 determines the PIN2 of the unauthorized call information is valid. Otherwise, if the PIN2 of the unauthorized call information is not the same as a PIN2 in the monitored mobile phone, then the determining module 102 determines the PIN2 of the unauthorized call information is not valid.

The allowed call list updating module 110 is configured for adding the phone number of the unauthorized call information to the allowed call list of the monitored mobile phone 1 if the PIN2 of the unauthorized call information is valid.

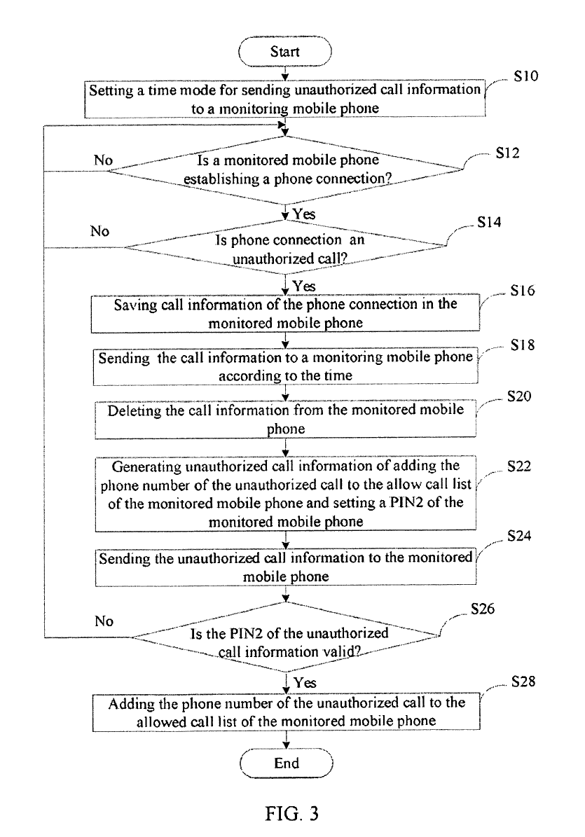

FIG. 3 is a flowchart illustrating one embodiment of a method for monitoring a monitored mobile phone. The method of FIG. 3 may be used to identify if an authorized user of a phone is calling the monitored mobile phone 1. Depending on the embodiment, the blocks may be rearranged, blocks may be added, or others removed.

In block S10, the setting module 100 sets a time for sending an unauthorized call information to the monitoring mobile phone 2.

In block S12, the determining module 102 detects whether the monitored mobile phone 1 is establishing a phone connection.

When the monitored mobile phone 1 is establishing a phone connection, in block S14, the determining module 102 determines if the phone connection is an unauthorized call.

If the phone connection is an unauthorized call, in block S16, the storing module 104 saves call information of the phone connection in the monitored mobile phone 1. As mentioned above, the call information may include at least one of a phone number of the unauthorized call, a date of the authorized call, and a time of the unauthorized call.

In block S18, the call information sending module 106 sends the call information to the monitoring mobile phone 2 according to the time.

In block S20, the delete call information module 108 deletes the call information from the monitored mobile phone 1.

In block S22, the unauthorized call information generating module 200 generates unauthorized call information of adding the phone number of the unauthorized call to the allow call list of the monitored mobile phone 1 and sets a PIN 2 of the monitored mobile phone 1.

In block S24, the unauthorized call information sending module 202 sends the unauthorized call information to the monitored mobile phone 1.

In block S26, the determining module 102 determines whether the PIN2 of the unauthorized call information is valid. If the PIN2 of the unauthorized call information is the same as a PIN2 in the monitored mobile phone 1, then the determining module 102 determines that the PIN2 of the unauthorized call information is valid. Otherwise, if the PIN2 of the unauthorized call information is not the same as a PIN2 in the monitored mobile phone 1, then the determining module 102 determines that the PIN2 of the unauthorized call information is not valid.

In block S28, the allowed call list updating module 110 adds the phone number of the unauthorized call to the allowed call list of the monitored mobile phone 1 if the PIN2 of the unauthorized call information is valid.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for monitoring a monitored mobile phone that communicates with a monitoring mobile phone via a communication network, the system comprising:
a determining module configured for detecting if the monitored mobile phone is establishing a phone connection to a first phone via the communication network, and for determining if the phone connection is an unauthorized call;
a setting module configured for setting a time for sending an unauthorized call information to the monitoring mobile phone, wherein the unauthorized call information comprises information about the first phone;
a storing module configured for saving the unauthorized call information of the phone connection in the monitored mobile phone upon the condition that the phone connection is an unauthorized call; and
a call information sending module configured for sending the unauthorized call information to the monitoring mobile phone according to the set time.

2. The system as claimed in claim 1, further comprising an allowed call list updating module, an unauthorized call information generating module, and an unauthorized call information sending module, wherein:
the unauthorized call information generating module is configured for generating the unauthorized call information, wherein the unauthorized call information generation module is configured for adding a phone number of the unauthorized call to an allowed call list of the monitored mobile phone, and setting a PIN2 for the monitored mobile phone;
the unauthorized call information sending module is configured for sending the unauthorized call information to the monitored mobile phone; and
the allowed call list updating module is configured for adding the phone number of the unauthorized call to the allowed call list of the monitored mobile phone upon the condition that a PIN2 of the unauthorized call information is valid.

3. The system as claimed in claim 1, further comprising:
a delete call information module configured for deleting the unauthorized call information from the monitored mobile phone.

4. The system as claimed in claim 1, wherein information about the first phone comprises at least one of a phone number of the first phone, a date of the phone connection, a PIN2, and a time of the phone connection.

5. A method for monitoring a monitored mobile phone that communicates with a monitoring mobile phone via a communication network, the method comprising:
setting a time for sending an unauthorized call information of the monitored mobile phone to the monitoring mobile phone via the communication network;
detecting if the monitored mobile phone is establishing a phone connection to a first phone;
determining if a communication between the monitored mobile phone and the first phone is an unauthorized call, wherein the determining includes verifying if a phone number of the unauthorized call matches a phone number in the monitored mobile phone;
saving a call information of the communication between the monitored mobile phone and the first phone in the monitored mobile phone upon the condition that the communication is an unauthorized call; and
sending the call information to the monitoring mobile phone according to the set time.

6. The method as claimed in claim 5, further comprising:
generating an unauthorized call information so as to add the phone number of the first phone to an allowed call list of the monitored mobile phone, and setting a PIN2 for the monitored mobile phone;
sending the unauthorized call information to the monitored mobile phone; and
adding the phone number of the unauthorized call information to the allowed call list of monitored mobile phone if the PIN2 of the unauthorized call information is valid.

7. The method as claimed in claim 5, further comprising:
deleting the call information from the monitored mobile phone.
